(19) United States
(12) Patent Application Publication
(10) Pub. No.: US 2009/0078756 A1
(43) Pub. Date: Mar. 26, 2009

(54) Method and Apparatus for Identifying and Dispensing Currency and Non Cash Media from Automated Teller Machine or Cash Dispensing Device

(76) Inventor: Stephen L. Oberan, Salem, OR (US)

Correspondence Address: ETHERTON LAW GROUP, LLC, 5555 E. VAN BUREN STREET, SUITE 100, PHOENIX, AZ, 85008, US

(21) Appl. No.: 12/058,358

(22) Filed: Mar. 28, 2008

Related U.S. Application Data
(63) Continuation of application No. 11/553,119, filed on Oct. 26, 2006, now abandoned.

(51) Int. Cl. G06Q 40/00

(52) U.S. Cl. 235/379

(57) ABSTRACT

Disclosed is a non-cash media card that is dispensable through automated teller machines (ATM's), with the card having information that identifies a particular customer and the particular transaction by which the card was purchased. Also disclosed is a process for dispensing the non-cash media card from an automated teller machine, by which a non-cash media card is dispensed through the same mechanism as cash is dispensed, and the ATM is configured to embed purchaser- and transaction-specific information on the card and to read the information to verify it.

### CROSS-REFERENCE TO RELATED APPLICATIONS

This application is a continuation-in-part application of application Ser. No. 11/553,119, filed Oct. 26, 2006 which is pending, and incorporated herein by this reference.

### FIELD OF THE INVENTION

The present invention generally relates to identifying any item being dispensed to a user, primarily currency and non-cash media, which is dispensed to a user through an automatic teller machine, and which is identified by technology enhanced readers or scanners that read various identifiers embedded, affixed, or pre-printed, either by design or configuration, as mandated by federal or banking regulations for security purposes. Such reader/writer/scanner devices are configured to identify various identifiers and are part of the internal working of the ATM. Other methods for identifying non-cash media dispensed from an ATM may include affixing or embedding an identifier such as a bar-code, RFID chip, biometric information, optical scanning, or a magnetic strip or any other method for identifying dispensed cash or non-cash media.

Cash/currency that is dispensed through an ATM still has identifying marks, such as the serial number on the face of the bill. By scanning the serial number, or other identifiers of the object, an electronic object identity file created from the scan may become associated with the user profile information.

### BACKGROUND OF THE INVENTION

Automated teller machines (ATM's) were introduced in the mid 1970's. These are machines that dispense cash to a user, typically after the user inserts a card with electronically-encoded information, such as a name and an account number. The value of the cash dispensed is deducted from one of the user's bank accounts and shows up on his or her bank statement. Currently, ATM's can be found in the lobbies of banks, in drive-though installations, in malls, in gas stations, in grocery stores, in airports, and in any place where a customer may need to obtain cash.

It is common that ATM's also dispense certain non-cash documents, such as receipts, or information about a client's account balance. These documents are printed within the machine upon demand and are typically produced and presented through a separate delivery slot than that through which the cash is presented to customers.

There are also ATM's presently available for use by consumers that dispenses such objects as stamps, phone credit or coupons in paper format that entitles the user to a certain monetary value pertaining to the paper object being delivered. Because most ATM machines are limited to paper delivery, it is impractical to offer to the customer a wide selection of non-paper objects to be dispensed from these machines which has value to the user and which is selectable by the user through an ATM interface. Non cash media containing value and having memory storage capability with specific individual identifiers are not currently found in ATM transactions through the ATM cash or media cassettes.

Such objects of value with information storage capacity and specific identifiers which may be dispensed could include admission tickets to events or locations, travel passes, cards with encoded memories, such as phone cards or gas cards, cards with computer chips with encoded memory, collectable cards, gift cards, cards with punch outs for goods or services, bar codes or other identifiers, cards redeemable for goods and services, or any other card-like instrument which has value to the consumer. To be dispensable from an ATM, the objects being dispensed would have dimensions and characteristics which correspond to the full spectrum of dispensing parameters of the ATM machine from which it is dispensed. From such an ATM dispensable object, one configuration of the object could contain a sheet configured with a separable card which could be removable from the sheet and/or a design allowing for several cards in one sheet either separable and/or foldable containing identifiers. The card with its identifier and memory information storage capability could be a pass to an event, transit pass, gift card or any other previously listed embodiment. If it contained information storage capability, this card could be flexibly loadable stored value card with value for commerce or updated with new memory information. This information storage capability with its specific and unique identifier may allow a user to flexibly “load” value or reload value from an associated and identified account. Since the dispensed object could be the full size of the dispensing parameters of currency or other non cash media dispensed by that particular ATM machine, the dispensable sheet presents the opportunity for advertising, printed instructions, or other information to be presented to the user.

Accordingly, the current application provides a method and apparatus with ability to identify, verify, and validate any non-cash media before being dispensed from the ATM machine or any ATM type machines configured to deliver cash or non cash stored value media for use in any electronic POS transaction, transaction of value or commerce, or in any ATM machines or ATM type machines configured to deliver cash or non cash media.

Accordingly, the current application provides a method and apparatus with the ability to identify, verify, and validate currency before being dispensed from the ATM or from any ATM type machines configured to deliver or count cash for use in commerce or any use for which cash is used. As cash is identified and a electronic file is created for the ATM transaction it is then attached to the electronic file of the account from which the cash was credited or debited.

Additional objects, advantages and novel features of the invention will be set forth in part in the description as follows, and in part will become apparent to those skilled in the art upon examination of the following, or may be learned by practice of the invention. The objects and advantages of the invention may be realized and attained by means of the instrumentalities and combinations particularly pointed out in the appended claims.

### SUMMARY OF THE INVENTION

According to the present invention, the foregoing and other objects and advantages are obtained by the ability to identify, verify, validate and track currency and any non-cash media sheet(s) containing value for use in commerce or any transaction for which value is exchange. The ATM would be configured to identify and dispense any number of currencies and non currency media of different size and configuration. Since the cash and non-cash media may be of different dimensions, ATM machines are configured by manufactures to process cash or non-cash media of a number of dimensions.

The ability to identify and track cash and non-cash media is desirable to many consumer groups, retailers, banking regulators, and governmental agencies. Consumers may also desire to track their information for a number of reasons, including but not limited to tax reasons, budgeting, or tracking information.

The characteristics of the non-cash media offers variable uses and variable designs as in a single or multiple sheet or cards, single or multiple, detachable or foldable, and will comprise but not limited to similarities to the currency that the ATM processes in terms of the side edge characteristics, the flex and stiffness tolerances, the roughness tolerances, the thickness tolerances, the weight tolerances, the tear tolerances, the length and width tolerances, the porosity tolerances, and the contrast ratio opacity tolerance. Other parameters for dispensing objects from an ATM will become apparent to users in the field.

The non-cash media could be a ticket allowing entry to an event, a location or a pass to ride public transportation. It could also be a collectable card, such as a card for a sports figure or to commemorate an event. If the card involves stored value, each subsequent transaction could reduce the remaining value chargeable on the card. Some uses of this card could be for telephone charges or for gas purchases, but could be utilized for any purchase for which a card reader or scanner is available. For non-cash media as described above, which contains a separable portion with information storage media, the value chargeable to the card can be augmented by a subsequent transaction in an appropriate machine or by the user at the ATM by making a phone call, by face-to-face transaction, or by other industry-acceptable ways of augmenting value. The non-cash media may be affixed, imprinted, embedded, or, as technologies allow, encoded with an identifier and may further allow for flexible information storage or for processing encrypted information regarding the object being dispensed to the receiver or purchaser, regarding a cash-receiving transaction, or regarding buying non-cash media. Due to this identification of this information, currency and non-cash media can be tracked as it is used, and value can be uploaded to the card subsequent to the original transaction. The reading of the information can be information stored on the memory media of the non cash media or currency. The identifier may contain identifying information that has been uploaded to the media, wherein the identifier could be read at a location and information about the transaction submitted to a database. The identifier may also be a passive type identifier wherein the identity of the object is recorded and, at the place of the transaction, the identifier is scanned. When the information about the transaction is transmitted to the database, the identity of the object may be associated with the proper user identity.

Various identifiers are capable of being implemented in the system. The identifier may comprise preconfigured identifiers, such as embedded RFID tags, pre-programmed magnetic strips, optical strips, serial numbers, bar codes, or holograms. The identifier may also be one that is capable of being generated on the spot, such as any number of different printing techniques both visible and invisible in the visual spectrum or a bar code imprinted on the card. The identifier information can be configured on all the non-cash media loaded into the ATM. If the identifier information is preconfigured, the transaction information would be sent from the ATM to a computing data center, and the purchaser and transaction information would be associated with the identifier at that point. Bar code or other identifiers maybe affixed or embedded or printed by appropriate processes required by each identifier for non-cash media. The identifier can also be imprinted by electronic means, as electronic data on a magnetic, optical, or other storage medium.

Another way that information can be associated with the transaction is by the use of RFID (Radio Frequency Identification). An RFID tag is an object that can be attached to or incorporated into a product, animal, or person for the purpose of identification and tracking using radio waves. Chip-based RFID tags contain silicon chips and antennas. Passive tags require no internal power source, whereas active tags require a power source. It has been dubbed the “contactless” card or system for doing what the other cards do. RFID tags used in this situation would be encoded with the same information as is conveyed in a bar-code. An RFID receiver would be set up on the card to respond to a unique specific frequency, and every time the non-cash media is used with that frequency, the user would be identified.

Cash, on the other hand, may be identified by noting the unique identifiers on the face of the bill. Such unique identifiers may include but are not limited to, the surface appearance of the bill, embedded smart bill technology, creating unique attributes on the face of the bill, or the visual serial number on the face of the bill. Information regarding the visible serial number on the bill may be collected by the use of a visual scan of the bill. The scanned data would then be uploaded to a computer database and stored as an image and code of the dispensed cash transaction. In some embodiments, the unique identifying information may be indexed, whereby the unique identifiers of the bills are quantified and sorted according to a predetermine criteria. This indexing system may be as simple as storing the serial number of the cash or by assigning values to image files or to the different physical characteristics of the bill.

Also described is a process for dispensing cash or non-cash media that is associated with a particular transaction from an ATM through the same mechanism through which the cash is dispensed.

The reading/writing/scanning process of the present apparatus and method thus provides a process for identifying, validating, verifying, and associating the transaction of any individual purchaser or receiver and record the original transaction of any dispensable item from an ATM or ATM-like device before allowing the currency or non-cash media to be dispensed. This provides a more secure method for dispensing a variety of items, including cash and value-added cards, which is not presently available. The ATM delivery has the unexpected benefit of reducing shrinkage in non-cash media due to losses from theft. This apparatus and method is also an unexpected and not apparent use of an ATM.

Still other objects and advantages of the present apparatus and method will become readily apparent to those skilled in this art from the following detailed description wherein I have shown and described only the preferred embodiment of the apparatus and method, simply by way of illustration of the best mode contemplated by carrying out my apparatus and method. As will be realized, the apparatus and method are capable of modification in various obvious respects, all without departing from the apparatus and method. Accordingly, the description is to be regarded as illustrative in natures and not as restrictive.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present apparatus and method will become readily apparent to those skilled in this art from the following detailed description describing preferred embodiments of the apparatus and method, simply by way of illustration of the best mode contemplated by carrying out my apparatus and method. As will be realized, the apparatus and method are capable of modification in various obvious respects all without departing from them. Accordingly, the description of the preferred embodiments is to be regarded as illustrative in nature, and not as restrictive in nature.

### DESCRIPTION OF THE PREFERRED EMBODIMENTS

While the apparatus and method are susceptible of various modifications and alternative constructions, certain illustrated embodiments thereof will be described below in detail. It should be understood, however, that there is no intention to limit the apparatus and method to the specific form disclosed, but, on the contrary, the apparatus and method are to cover all modifications, alternative constructions, and equivalents falling within the spirit and scope of the apparatus and method as defined in the claims.

The preferred embodiment of the apparatus and method is a system for reading/scanning/writing any item being dispensed from an automated teller machine (ATM) or ATM-like device that offers cash and non-cash media from a cash or media cassette. In such a system, the identification and tracking allows for validation and tracking of currency and non-cash media being dispensed from an automated teller machine (ATM) or ATM-like device, and in which the non-cash media can be associated with an individual purchaser and transaction through an identification process employed within the ATM. This may be accomplished in various ways, each with a different level of complexity. Identifiers may be from several technologies such as visual scanning of said cash and non-cash media, bar code, holograms, biometrics, RFID, micro-chips sets, custom printing, or any other method of identifying or creating an identifier on a card comprising the ability to send or receive information and store encrypted fixed or flexible information.

The method comprises the initial step of the user inputting the information relating to the identity of the user. This may comprise of an ATM card and PIN combination, online access, telecommunication access, or may comprise more elaborate systems of biometrics, self verification systems, direct input of personal information into the ATM, or the ability to create an alias for identifying an alternate user.

By initially identifying the user, the ATM is then able to access a myriad of prior information that has been uploaded into a database. This information can include more detailed information about the user, as well as historical information, such as past purchases, bank accounts, location information, or any other information about the user contained in a database. By accessing the personal database, a record of the transaction can be made wherein the identity of the user and the dispensed cash or non-cash media may be associated.

Next, a selection of choices is presented to the user. While not intended to be restrictive but instead illustrative, this selection could comprise a cash transaction, informational media, tickets to a concert or sporting event, rail pass, or a variable value added pre-paid card.

Once the cash or non-cash media to be dispensed has been selected by the user, the ATM will identify the object to be dispensed. Depending upon the type of identifying information, this step may comprise a visual scanning of the face of the object to be dispensed, creating a unique electronic code for the document, storing and transmitting the new electronic file with code, mating the new file and code with the bank identification number of the transaction, terminal number and personal profile of the user that initiated the ATM transaction. This information may thus be recorded and sent to one or more databases for processing. The information in the database may be in a raw form, such as a scanned image of dispensed cash, or in an indexed form wherein the information is processed into a reliably-accessible form including but not limited to optical character recognition. Methods for identifying objects are not exclusive multiple methods may be employed in a single ATM or ATM like machine to identify cash and non cash media dispensed from the ATM or ATM like device. Dispensing of the object from the ATM allows the identity of an object may be associated as being in the possession of a user.

The information within the database would be stored and retrieved when a transaction is initiated. These transactions may include, but are not limited to, use of the dispensed object at a sporting event, concert, or train station, use of cash to make a purchase, use of a media card to make a purchase of goods, services, or any other type of transaction. Information about the type of transaction such as location, type, time, or other information is relayed to at least one database, and a record of the transaction and transaction identifying files with any specific code is saved. In this manner, information such as the location of a transaction can be recorded.

This may be accomplished in validating and identifying currency by serial number or all current identifiers used to validate non-counterfeit currency of any denomination or country and track said currency by identifying the electronic profile of the file that requested and accepted the currency from an ATM or ATM device. In non-cash media it may be preprinted with a preconfigured identifier, in which the ATM dispensing the non-cash media would be configured to read the identifier as the media is dispensed. In another embodiment, the device could include an ATM that could be configured to encode the dispensed object with information specific to the purchaser and a particular transaction. In this manner, the object could always be identified as arising from the transaction. This could be by any function, as designed and accepted by the specific identifier being used on the non-cash media, incorporated in the apparatus and method of the scanning/reading and writing system deployed in the ATM.

While maintaining these physical characteristics, the non-cash media can be configured to serve as an admission ticket to events or locations. It can also be configured to carry an image that makes the card collectible, such as an image of a sports figure. The card can be configured with punch-outs for goods or services, in which a region of the media is removed to indicate that goods have been received or a service has been performed. When all of the punch-outs of the cards are utilized, the user would have to buy a new card with punch-outs. The non-cash media may also be redeemable for goods or services, such as a car wash, a carpet cleaning, a hot air balloon ride, or any number of goods or services. The media could also have regions with encoded memory on which subsequent transactions would be recorded to diminish or augment the stored value on the card. The memory could be in the form of a magnetic strip or strips, computer chips, RFID chips, bar codes, Biometrics, holograms, optical recognition or other means of storing data for identification.

All items being dispensed will have an identifier for associating cash or non cash media to a particular transaction. The identification element on the card may be on the front, back, or even within the dispensed object, and may be on both the removable or foldable portion of the media.

A convenient and easy way to integrate (bar codes or their equivalent) identifiers into the cash and non-cash media dispensing system is to incorporate a scanner/reader/writer system in the dispensing and delivery system of the ATM or ATM-like device. In one configuration, as the object to be dispensed is first picked from the ATM cassette (depending on the type of cassette), where it will pass by one or more scanner/reader/writer units that scans/reads/writes the identifier on the cash or non-cash media. Some ATM cassettes have a partially opened or windowed portion when locked in place into the ATM as a part of their interfacing software and mechanism that would allow for the identifiers to be visible as the next to be dispensed. As it is picked up by the dispensing mechanism and travels through the dispensing channel, most have a place where they are once again checked for any details or problems before being presented at the outlet of the ATM. At any point before delivery of items at the presenter, the ATM may utilize a second reader for final verification of the identifier.

The information relating to the user and the transaction is stored in the memory of the ATM like any other cash transaction, plus it is sent to the processor. The system will have the capability of tracking the card and linking it to the account that purchased it from the ATM. When the card is purchased, it is by way of credit card, ATM card, or Debit card, where all of the account holder's information is accessed during the transaction. This allows the capacity to identify which media were purchased by what type of payment instrument and who purchased the media for tracking purposes and for the next step in allowing for a flexible load to the media.

Flexible load means the customer may now tell the ATM how much money he or she wants on this stored value card he or she is requesting to purchase verses having to place pre-denominated stored value media in the ATM only. By associating the dispensed media with the identity of the user, the user can select increments different than that which is normally available. A user may be able to customize a dispensed media so that the value on the media is exactly the amount required to make a purchase, thereby increasing the security and privacy of a transaction.

The identifier may be configured to allow any item carrying an identifier to be identified by one or more scanner/reader/writer within the ATM, which will allow for other function and benefits such as tracking the media for inventory control, and then for that media (file and number held on the server of the card issuer) to be linked to the purchaser by identifying any media being dispensed from the ATM. Linking the media to a particular purchaser allows the purchaser to reload the value on the card, or at the time of purchase to place an amount on the card of his or her choosing rather than buying a pre-denominated value. It also has importance in creating a classification of the type of transaction as determined by credit card companies and the processors. By associating the identity of the user with the transaction, the transaction may be classified, for banking purposes, as an electronic funds transfer (EFT) transaction verses a POS (point of sale) transaction only. An EFT transaction is a transfer of funds, other than a transaction originated by check, draft, or similar paper instrument, which is initiated through an electronic terminal, telephone instrument, or computer or magnetic tape to authorize a financial institution to debit or credit an account.

POS, on the other hand, is an electronic payment system in a merchant's location where consumers pay for retail goods and services through the use of credit cards or debit cards that directly access and deduct funds from the customer's checking account.

When someone comes to the ATM for any transaction, the card they use to initiate the transaction will identify the person at the ATM and his or her banking account or at least the account linked to the card he or she chooses to use to initiate the transaction. When he or she is identified, his or her profile will contain all his or her account information on the bank's network and servers. This is the means in which the plastic card is linked to the customer, account numbers, and PIN numbers so the customer can be verified and the transaction completed.

With the customer now verified and having his or her profile accessed, the newly dispensed non-cash media card can now be linked to his or her profile like any other card. Accordingly, if he or she chooses later to reload (adding more value to the card), he or she can do so at the ATM or even at another location. It also will give the system a real-time ability. Accordingly, if he or she chooses to place more funds beyond the predenominated value on the card at the time of purchase, he or she can elect to do so with money from either his or her checking, savings, or credit account. Now this card belongs to him or her like his or her credit, debit, or ATM card, and he or she can add more money to the account that he or she has just opened, as if transferring funds from one account to another.

The identifier identifies the dispensed object and may be done for inventory control and then assigns the media to the purchaser. The identifier is the link to the server file of the card issuer only for that card. Once it is identified and tagged to the profile of the purchaser, it becomes part of the purchaser's new profile. The system will know when it was purchased, where, by what profile and if any funds were added to it beyond the predenominated funds. The system will also be able to give the option of offering a card with no predenominated funds and let the customer determine how much he or she would like on this gift or stored value card.

Once the object to be dispensed is identified, the object can be dispensed from the ATM while information about that transaction can be stored in at least one primary database. The information in the database will be stored and will remain there until another transaction with the media occurs. At the site of the secondary transaction, the object may once again be scanned and the information about the secondary transaction may be compared to the information retained in the primary database. In this manner, information about the secondary transaction may be recorded and associated with the user.

In another preferred embodiment of the apparatus and method, the apparatus and method involve a process for dispensing a non-cash media card from an ATM machine. The non-cash media card is a card as described above, which is selected by a user through the ATM interface, and dispensed from the ATM through the same apparatus, currency cassettes, as that which is used to dispense cash.

While there is shown and described the present preferred embodiment of the apparatus and method, it is to be distinctly understood that the apparatus and method are not limited thereto, but may be variously embodied to practice within the scope of the following claims. From the foregoing description, it will be apparent that various changes may be made without departing from the spirit and scope of the apparatus and method as defined by the following claims.

I claim:

1. A method for tracking consumer information comprising the steps of:
inputting information into an ATM used to identify a profile of a user;
accessing said user's profile information from within a database;
displaying a selection of transactions available to a consumer through said ATM;
selecting cash or non-cash media from within said transactions;
identifying said cash or non-cash media;
associating said identified cash or non-cash media with said profile information from said ATM by creating an electronic file for the transactions preformed at said ATM;
dispensing said cash or non-cash media from said ATM to said user;
storing said associated information within at least one database;
collecting information when said user initiates a transaction; and
relaying information from said transaction to said at least one database wherein said relayed transaction information may be associated with said information within said at least one database.

2. The method of claim 1 wherein said identifying step further comprises scanning visual identifiers of said cash or non-cash media using optical scanner/reader technology inside said ATM.

3. The method of claim 1 wherein said identifying step further comprises creating a machine-readable identifier of said cash or non-cash media using bar code technology inside said ATM as an identifier.

4. The method of claim 1 wherein said identifying step further comprises identifying said cash or non-cash media using a radio frequency identification passive tag and receiver inside the ATM, wherein said radio frequency identification receiver is configured to receive and transmit data from said non-cash media RFID identifier.

6. The method of claim 1 wherein said identifying step further comprises identifying said non-cash media using at least one magnetic strip, said magnetic strip configured to provide machine-readable means of identification of said non-cash media.

7. The method of claim 1 wherein said identifying step further comprises identifying said cash or non-cash media by affixing said cash or non-cash media with an identifier.

8. The method of claim 1 wherein said identifying step further comprises identifying said cash by reading identifiers accepted by governmental agencies regulating cash.

9. The method of claim 1 wherein said identifying step further comprises identifying said cash or non-cash media by identifying a hologram attached to said cash or non-cash media.

10. The method of claim 1 wherein said step of inputting information into an ATM used to identify a profile of a user comprises measuring biometric information of said user.

11. The method of claim 1 wherein said step of inputting information into an ATM used to identify a profile of a user comprises telecommunication initiation to said ATM from said user.

12. The method of claim 1 wherein said step of inputting information into an ATM used to identify a profile of a user comprises magnetic strip initiation, by said user.

13. An ATM configured to identify the objects dispensed from said ATM comprising:
an interaction unit for displaying a selection of choices to an ATM user, said interaction unit configured to permit said user to input said user's profile information and to make selections from within a pre-selected list of transactions;
at least one identifying unit, said identifying unit configured to recognize and identify the object to be dispensed from said ATM;
at least one database, wherein said at least one database is configured to retain and communicate said information from said at least one identifying unit and said user profile information,
a dispensing unit, said dispensing unit configured to dispense said identified object from said ATM;
a secondary transaction recording device, configured to communicate with said database information relating to a secondary transaction at a secondary transaction site;
wherein said identified object dispensed from said ATM is associated with said profile information by said database and said secondary transaction information relays use of said dispensed object at said secondary transaction site.

14. The apparatus of claim 13 wherein said identifying unit is configured to imprint said dispensed object with a unique identifier so as to personalize said dispensed object with said unique identifier.

15. The apparatus of claim 13 wherein said identifying unit further comprises an optical scanning device, for scanning the visual identifiers of said cash or non-cash media.

16. The apparatus of claim 13 wherein said identifying unit further comprises a bar code for creating a machine-readable identifier of said cash or non-cash media.

17. The apparatus of claim 13 wherein said identifying unit further comprises a radio frequency identification tag, wherein said radio frequency identification tag is configured to receive and transmit a cash or non-cash media identifier for identifying said cash or non-cash media.

18. The apparatus of claim 13 wherein said interaction unit further comprises a biometric measuring means for accessing said profile information by measuring said biometric information from said user.

19. The apparatus of claim 13 wherein said identifying unit further comprises at least one magnetic strip, said magnetic strip configured to provide a machine-readable means of identifying said cash or non-cash media.

20. The apparatus of claim 13 wherein said identifying unit further comprises at least one holographic reader, said holographic reader configured to read a hologram located on said dispensed media so as to identify said dispensed media.

21. The apparatus of claim 13 wherein said dispensed non-cash media comprises a flexibly loadable stored value card wherein said flexibly loadable stored value card said identifier and is configured to link said flexibly loaded card with said profile information and said transaction information, said link configured to allow a bank and stored value card issuers or stored value card platforms to electronically activate and transfer funds to said flexibly loadable stored value card.
